(19) United States
(12) Patent Application Publication
(10) Pub. No.: US 2005/0205601 A1
(43) Pub. Date: Sep. 22, 2005

(54) Water dispensing systrem with vaccum-filled metering chamber

(76) Inventor: Jon Taylor, Groton, MA (US)

Correspondence Address: WOLF GREENFIELD & SACKS, PC;FEDERAL RESERVE PLAZA, 600 ATLANTIC AVENUE, BOSTON, MA, 02210-2211, US

(21) Appl. No.: 10/790,533

(22) Filed: Mar. 1, 2004

(51) Int. Cl. B67D 5/08

(52) U.S. Cl. 222/53

(57) ABSTRACT

A system for dispensing a metered volume of heated water from the storage tank to the brew chamber of a single serve beverage brewer comprises a metering chamber, a supply conduit connecting the storage tank to the metering chamber, and a delivery conduit connecting the metering chamber to the brew chamber. An air pump coacts with associated valves to alternately withdraw heated water from the storage tank into the metering chamber via the supply conduit, and to expel heated water from the metering chamber via the delivery conduit to the brew chamber.

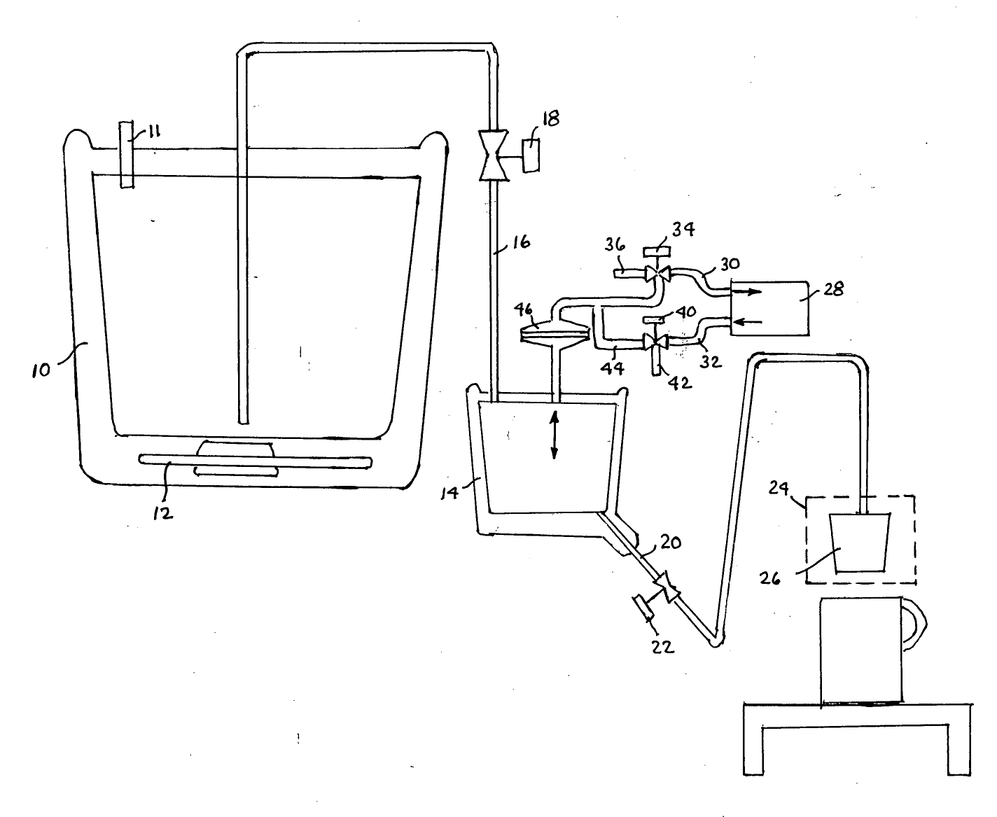

### CROSS REFERENCE TO RELATED APPLICATIONS

This application claims priority of provisional patent application Ser. No. 60/450,002 filed Feb. 25, 2003.

### BACKGROUND OF THE INVENTION

1. Field of the Invention

This invention relates generally to single serve beverage brewers, and is concerned in particular with an improved system for repeatedly dispensing the metered amounts of heated water required to effect successive brew cycles.

2. Description of the Prior Art

Known water dispensing systems for single serve beverage dispensers commonly employ buoyant and/or mechanically activated metering components. Such systems are relatively complex and expensive, and are prone to developing sealing problems due to a build up of mineral deposits at critical interfaces.

The objective of the present invention is to provide an improved air-activated system that avoids or at least significantly minimizes the above-mentioned shortcomings.

### SUMMARY OF THE INVENTION

In accordance with the present invention, a system for dispensing a metered volume of heated water from the storage tank to the brew chamber of a single serve beverage brewer comprises a metering chamber, a supply conduit connecting the storage tank to the metering chamber, and a delivery conduit connecting the metering chamber to the brew chamber. An air pump coacts with associated valves to alternately withdraw heated water from the storage tank into the metering chamber via the supply conduit, and to expel heated water from the metering chamber via the delivery conduit to the brew chamber.

These and other features and advantages of the present invention will now be described in greater detail with reference to the accompanying drawing, wherein:

### BRIEF DESCRIPTION OF THE DRAWING

The single FIGURE is a schematic illustration of a system in accordance with the present invention.

### DETAILED DESCRIPTION OF THE PREFERRED EMBODIMENT

With reference to the accompanying drawing, a storage tank 10 contains a supply of water heated to an appropriate elevated temperature by a heater 12. The storage tank is vented to atmosphere at 11.

A metering chamber 14 is connected to the storage tank 10 by a supply conduit 16 which includes a first valve 18. The metering chamber 14 is also connected via a delivery conduit 20 and a second valve 22 to a brew chamber 24 adapted to receive a single serve beverage filter cartridge 26 of the type described, for example, in U.S. Pat. No. 5,840,189 (Sylvan et al.) and U.S. Pat. No. 5,325,765 (Sylvan et al.).

An air pump 28 has suction and discharge conduits 30, 32. A third valve 34 is adjustable to alternately connect suction conduit 30 to atmosphere via a vent 36 or to a conduit 38 communicating with the metering chamber 14. A fourth valve 40 is similarly adjustable to alternately connect discharge conduit 32 to atmosphere via a vent 42 or to a branch conduit 44 leading to conduit 38.

At the onset of a brew cycle, valve 22 is closed and valve 18 is opened. Valve 34 is set to connect the pump suction conduit 30 to the metering chamber 14 via conduit 38, and valve 40 is set to connect the pump discharge conduit 32 to the vent 42. The pump 28 thus operates to create a vacuum in the metering chamber 14, resulting in hot water being drawn into the metering chamber 14 from tank 10 via conduit 16.

When the metering chamber has been charged with the appropriate volume of hot water (a determination based either on a timed cycle or on a sensing of the water level in the metering chamber), valve 18 is closed, valve 22 is opened, and the settings of valves 34 and 40 are reversed. Thus, the air pump 28 now delivers pressurized air to the metering chamber via conduits 32, 44 and 38 while the pump suction line 30 communicates with the vent 36. The air being forced into the metering chamber causes water to be expelled therefrom via conduit 20 to the brew chamber 24. The brew chamber also may be of the type described in the above referenced U.S. patents, the disclosures of which are herein incorporated by reference.

Conduit 38 may be provided with one a way barrier component 46 such as a filter, condenser or the like to safeguard the air pump 28 against ingestion of water vapor or water drawn from the metering cup.

1. A system for dispensing a metered volume of heated water from the storage tank to the brew chamber of a single serve beverage brewer, said system comprising:
a metering chamber;
a supply conduit connecting the storage tank to said metering chamber;
a delivery conduit connecting said metering chamber to the brew chamber; and
air-activated means for withdrawing heated water from said storage tank into said metering chamber via said supply conduit, and for expelling heated water from said metering chamber via said delivery conduit to said brew chamber.

2. The system of claim 1 wherein said air-activated means comprises an air pump having suction and discharge conduits; and valve means operative in one mode for connecting said suction and discharge conduits respectively to said metering cup and to atmosphere to draw heated water from the storage tank via said supply conduit into said metering chamber while preventing water flow through said delivery conduit, and operative in an alternative mode for connecting said suction and discharge conduits respectively to atmosphere and to said metering chamber to expel heated water via said delivery conduit to said brew chamber while preventing water flow through said supply conduit.

3. The system of claim 2 wherein said valve means includes first and second valves located respectively in said supply and delivery conduits, a third valve for alternately connecting said suction conduit to atmosphere and to said metering chamber, and a fourth valve for alternately connecting said discharge conduit to atmosphere and to said metering chamber.

4. The system of claim 3 wherein said third and fourth valves are connected to a common conduit leading to said metering chamber.

5. The system of claim 4 further comprising barrier means in said common conduit for safeguarding said air pump against ingestion of water and water vapor from said metering chamber.
